(19) United States
(12) Patent Application Publication
(10) Pub. No.: US 2011/0018249 A1
(43) Pub. Date: Jan. 27, 2011

(54) SHOPPING CART OR TRANSPORT CONTAINER, AND PRODUCTION METHOD

(76) Inventors: HORST SONNENDORFER, PUCHHEIM (DE); FRANZ WIETH, PUCHHEIM (DE)

Correspondence Address: LERNER GREENBERG STEMER LLP, P O BOX 2480, HOLLYWOOD, FL, 33022-2480, US

(21) Appl. No.: 12/893,507

(22) Filed: Sep. 29, 2010

Related U.S. Application Data
(63) Continuation-in-part of application No. 10/589,588, filed on Aug. 16, 2006, now abandoned.
Application No. 10/589,588 is a continuation of application No. PCT/DE2005/000264, filed on Feb. 16, 2005.

(30) Foreign Application Priority Data
Feb. 16, 2004 (DE) 20 2004 002 438.1

(51) Int. Cl. B62B 3/00; B29C 45/00; B29C 47/00

(52) U.S. Cl. 280/781; 264/239

(57) ABSTRACT

A shopping cart or transport container is provided with ion-releasing surfaces that have anti-microbial efficacy. In addition, the surfaces are formed to be hydrophobic or superhydrophobic. The shopping cart or transport container therefore does not provide an environment that permits the survival of pathogens.

### CROSS-REFERENCE TO RELATED APPLICATION

This application is a continuation-in-part of our copending patent application Ser. No. 10/589,588, filed Aug. 16, 2006, which was a §371 national stage application of international application PCT/DE2005/000264, filed on Feb. 16, 2005, which designated the United States and claimed the priority of German patent application 20 2004 002 438.1 of Feb. 16, 2004; all of these prior applications are herewith incorporated by reference in their entirety.

### BACKGROUND OF THE INVENTION

### Field of the Invention

The invention relates to an improvement in the shopping cart and transport container art. More specifically, the invention pertains to a shopping cart, a shopping basket, a transport container, and to a method of producing such devices.

A large proportion of the shopping carts or transport containers in use have a surface made of zinc-plated, chrome-plated or painted metal. The so-called basket, that is to say the region in which the transported items, for example the purchased goods, are placed, consists of an interwoven structure of round metal bars. There are a small number of plastic shopping carts in existence. To achieve a sufficient degree of stability for the basket, the basket consists of plastic bars which are more solid than the metal bars.

As a result of use, shopping trolleys or transport containers are subject to soiling, making cleaning necessary at certain intervals.

For reasons of food hygiene regulations, shopping carts or transport containers in which foods is transported must be cleaned only with water without the addition of solvents. To increase the cleaning action of the water, the water is sprayed at a high temperature onto the regions to be cleaned using so-called steam jets. Depending on the degree and nature of the soiling, mechanical assistance in the form of brushing is additionally required.

On the one hand, this cleaning method requires a high degree of effort; on the other hand, this method achieves the desired result only when the cleaning is performed on shopping carts or transport containers made of metal. In the case of shopping carts or transport containers made of plastic, the conditions for cleaning are even more difficult since there are crevices at the junction points between the individual plastic bars and contaminating matter becomes deposited therein. The fact that the bars in plastic shopping carts are more solid than the metal bars results in long crevices. When cleaning plastic shopping carts or transport containers, these long crevices at the junction points between the bars again require special cleaning, which further increases the effort involved.

### BRIEF SUMMARY OF THE INVENTION

It is accordingly an object of the invention to provide a shopping cart or transport container and a method for producing such a device, which overcomes the above-mentioned disadvantages of the heretofore-known devices and methods of this general type and which provides for a shopping cart or transport container made of plastic or of a metal frame with plastic walls in which the cleaning effort is reduced and/or the surface does not offer an environment in which bacteria and/or fungi and their spores can take hold and/or multiply.

With the foregoing and other objects in view there is provided, in accordance with the invention, a shopping cart, comprising:

a shopping cart frame formed with molded plastic; and

said molded plastic containing ion-releasing material integrated into said molded plastic during a production of the shopping cart and having ion-releasing functionality at exposed surfaces thereof.

The term “shopping cart” will be used herein in its most generalized sense and the term should be understood as including similar transport containers that may not necessarily be used in a shopping environment, and also as including shopping baskets without rolling castors.

In accordance with an added feature of the invention, the ion-releasing functionality is not achieved by an additional coating on the exposed surfaces of said molded plastic. If the surface according to the invention is scratched, for example, the underlying and exposed material is still active in terms of delivering the ions to the surface. In the case of a thinly coated or coat-treated surface, such scratches would instead become a safe haven for the dreaded microbial and/or fungal activity

In accordance with an added feature of the invention, the shopping cart frame consists essentially of said molded plastic. For example, except for the wheels and/or locking features, and/or reinforcing bars, the entire cart may be formed of molded plastic.

In accordance with an added feature of the invention, the molded plastic is ASA (acrylonitrile styrene acrylate) and the ion-releasing material includes an amount of silver in the ASA at less than 1% by weight and distributed throughout the ASA. In the alternative, the molded plastic is PVC (polyvinyl chloride).

In accordance with an additional feature of the invention, the ion-releasing material is a silver-ion releasing material present in the molded plastic in an amount of substantially 0.2% to 0.4% relative to a mass of the molded plastic.

In accordance with a further feature of the invention, the exposed surfaces of said molded plastic material are formed with hydrophobic or superhydrophobic properties.

With the above and other objects in view there is also provided, in accordance with the invention, a method for manufacturing a shopping cart. The method comprises the following steps:

providing a base batch of moldable plastic material;

forming a further batch of the moldable plastic material with ion-releasing material;

mixing the base batch and the further batch at a ratio of greater than 9:1 to form a mixed batch of molding material;

molding the molding material to form elements of a shopping cart having exposed surfaces with the ion-releasing material providing anti-microbial functionality, and forming a shopping cart with ion-releasing exposed surfaces.

In accordance with an exemplary embodiment of the invention, the moldable plastic material is PVC or ASA and the base batch is provided in an amount of 96% to 98% of the molding material. The further batch is then provided in an amount of 2% to 4% of the molding material and the ion-releasing material in an amount of approximately 10% of the further batch. Accordingly, the ion-releasing material is then present in the molding material of approximately 0.2% to 0.4%.

In accordance with a concomitant feature of the invention, the shopping cart is formed with hydrophobic surfaces and/or with superhydrophobic surfaces.

The underlying consideration was that a hydrophobic surface of the shopping cart or transport container, this surface additionally having a so-called nanostructure, in most cases does not give the contaminating matter sufficient surface to adhere firmly. Such a surface then has so-called superhydrophobic properties.

Contaminating matter which nevertheless remains clinging to the dry surface can then be removed easily and virtually without a trace with normal running water. The water itself here drips off the surface virtually without trace and in the process takes up the contaminating matter adhering to the surface and transports this matter away.

Such a surface is described in U.S. Pat. No. 7,196,043 B2 (WO 96/04123), assigned to S.C. Johnson & Son, Inc. The corresponding technology can be used in a novel and inventive way to reduce the cleaning effort required for shopping carts. The disclosure of the patent is herewith incorporated by reference.

With regard to shopping carts having a basket made of plastic, an economically expedient use in the food industry is possible for the first time, since it is only with the present invention that the specific problem of firmly adhering dirt in the corners of the bar junction points is eliminated.

If the shopping cart is exposed to rain, the cleaning is effected by the rainwater itself.

A further consideration was that pathogens such as fungi or bacteria which adhere to a shopping cart can be transferred from there to food situated within such a shopping cart. For fungi to be able to develop, the fungal spores must first germinate. The fungal spores require moisture for this germination. Here, as a result of its additional nanostructure, the hydrophobic or superhydrophobic surface in a shopping cart according to the invention has a twofold action against pathogens. The pathogens or fungal spores are washed off during each cleaning operation or by rainwater, and since all the water runs off from the surface of the shopping cart without a trace, the moist environment necessary for germination or survival is not available to pathogens.

At the same time, fungal spores which have adhered to the dry surface are taken along by the water running off and removed from the surface.

The use of materials that provide for a surface having ion-releasing properties makes it possible to kill any bacteria.

The use according to the invention of the combined hydrophobic or superhydrophobic and/or ion-releasing surface results in a shopping cart having the additional property of not providing an environment in which pathogens can survive.

Other features which are considered as characteristic for the invention are set forth in the appended claims.

Although the invention is illustrated and described herein as embodied in a shopping cart or transport container and a method for producing such a device, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a side view of a customary shopping cart made of steel; and

FIG. 2 is a side view of a shopping cart made of plastic.

### DESCRIPTION OF A PREFERRED EMBODIMENT OF THE INVENTION

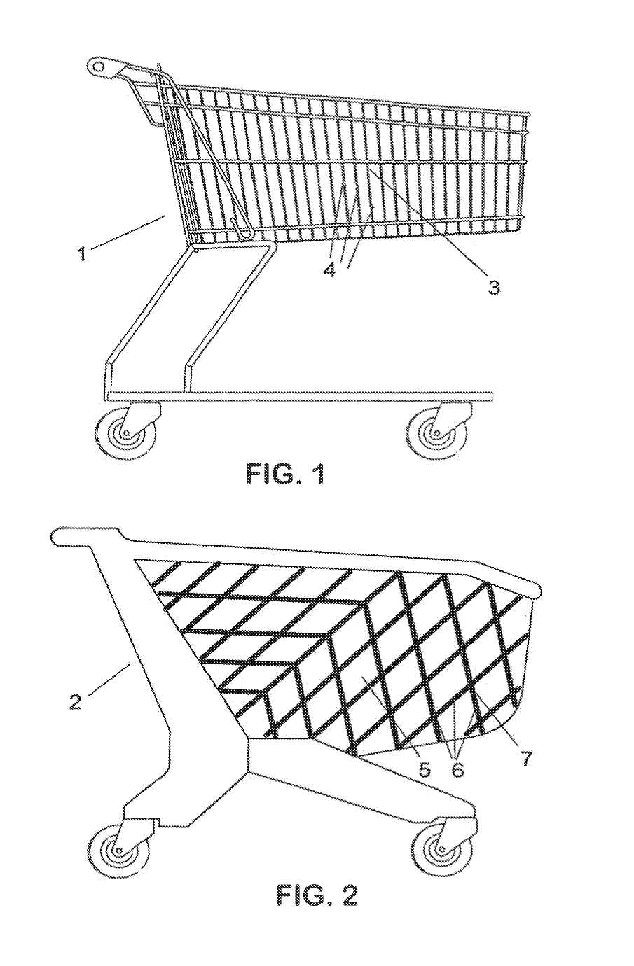

Referring now to the figures of the drawing in detail, FIG. 1 shows a shopping cart 1 that is generally formed of a metal carrier frame. FIG. 2 shows a shopping cart 2 that is made of plastic. The surfaces are designed to be hydrophobic or superhydrophobic and/or ion-releasing.

The hydrophobic or superhydrophobic and/or ion-releasing property of the surface can be achieved in the case of the steel shopping cart by coating with an appropriate material.

This coating may be applied to the shopping cart either during the primary production process or at a later time, for example during an overhaul.

It is preferable for only the basket 3, which consists of a multitude of metal bars 4, to be equipped with a hydrophobic or superhydrophobic and/or ion-releasing surface. The remaining regions of the shopping cart which cannot come into contact with the food remain without a specially treated surface.

In the case of the plastic shopping cart 2, the hydrophobic or superhydrophobic and/or ion-releasing surface is produced by appropriate production methods. Preferably, we use injection molding processes with ASA resins or extrusion processes with PVC (polyvinyl chloride) or ASA (acrylonitrile styrene acrylate). A wide variety of corresponding base materials are commercially available. Examples of suitable ASA resins are provided by BASF of Germany (e.g., Luran® ASA resins), or LG Chem of Korea. The materials are available in injection molding grades and in extrusion grades. Also, a variety of possibilities exist with regard to the reinforcement of these materials.

Our preferred molding process uses injection molding of ASA material and extrusion of PVC material. In either case, we first provide a base batch of 96% to 98% of standard material (i.e., ASA or PVC). We also provide a batch of 2% to 4% of the standard material with 10% of ion releasing material. These batches are then mixed, so that the final product contains 0.2% to 0.4% of ion releasing material.

Silver has proven to be a very efficient and suitable ion releasing material. Those of skill in the pertinent art will be able, however, to select other such ion releasing materials with corresponding and/or equivalent efficacy. Suitable materials are available, for example, from Microban International, Ltd. under the name Microban® 3G Silver and Zinc Antimicrobial Technologies.

The extrusion process and/or the injection molding process itself is carried out at the same process conditions (i.e., temperature, pressure, process speed, curing time, cooling time, etc.) as are prescribed for the standard material. In other words, it is not necessary to vary the process because of the addition of the ion releasing material.

In the case of conventionally produced plastic shopping carts, that is to say ones produced without a hydrophobic or superhydrophobic and/or ion-releasing surface, a subsequent integrative coating is possible. According to the invention, however, the metal bars and the like are not only coated with a thin film, but they are covered with a relatively thick coat having a thickness of more than 1/16 inch, or more than ⅛ inch, or even up to approximately ¼ inch or more.

The integration of the ion-releasing material in the carrier material itself—as opposed to surface treating and thin-surface coating—is very advantageous. With regard to a shopping cart handle, for instance, the entire handle itself becomes the source of the (antimicrobial) ions. If the handle consists of plastic, the entire volume provides for the antimicrobial activity. If the handle is made of metal that is covered with a (relatively thick) layer of plastic, the entire volume of the plastic still acts as the antimicrobially active structure and the source of the ions. If the handle is scratched, for example, the underlying and exposed material is still active in terms of delivering the ions to the surface. In the case of a thinly coated or coat-treated surface, such scratches would instead form a safe haven for the dreaded microbial and/or fungal activity.

The basket 5 of the shopping cart 2 consists of comparatively solid bars 6.

At the junction points 7 of a number of bars 6, there are angled regions at the transitions to the bars, in which regions contaminating matter stubbornly settles in the case of normal surfaces. It is precisely in these regions that the hydrophobic or superhydrophobic and/or ion-releasing surface according to the invention is particularly advantageous.

The invention can be applied to any type of transport container in which the easy cleaning of contaminating matter provides an advantage. Examples of such transport containers are cases, baskets or folding boxes used particularly for food shopping or storage.

The advantages of easy cleaning can equally also be applied to all other sectors in which transport containers are subject to soiling and they should be cleaned for further and repeated use. Simplification of the cleaning process and the avoidance of bacterial and fungal growth is thus a considerable advantage provided by the claimed invention.

1. A shopping cart, comprising:
a shopping cart frame formed with molded plastic; and
said molded plastic containing ion-releasing material integrated into said molded plastic during a production of the shopping cart and having ion-releasing functionality at exposed surfaces thereof.

2. The shopping cart according to claim 1, wherein said ion-releasing functionality is not achieved by an additional coating on the exposed surfaces of said molded plastic.

3. The shopping cart according to claim 1, wherein said shopping cart frame consists essentially of said molded plastic.

4. The shopping cart according to claim 1, wherein said molded plastic is ASA and said ion-releasing material includes an amount of silver in said ASA at less than 1% by weight and distributed throughout said ASA.

5. The shopping cart according to claim 1, wherein said molded plastic is PVC and said ion-releasing material includes an amount of silver in said ASA at less than 1% by weight and distributed throughout said ASA.

6. The shopping cart according to claim 1, wherein said ion-releasing material is a silver-ion releasing material present in said molded plastic in an amount of substantially 0.2% to 0.4% relative to a mass of said molded plastic.

7. The shopping cart according to claim 1, wherein said exposed surfaces of said molded plastic material are formed with hydrophobic or superhydrophobic properties.

8. A method for manufacturing a shopping cart, the method which comprises the following steps:
providing a base batch of moldable plastic material;
forming a further batch of the moldable plastic material with ion-releasing material;
mixing the base batch and the further batch at a ratio of greater than 9:1 to form a mixed batch of molding material;
molding the molding material to form elements of a shopping cart having exposed surfaces with the ion-releasing material providing anti-microbial functionality, and forming a shopping cart with ion-releasing exposed surfaces.

9. The method according to claim 8, which comprises:
providing ASA or PVC as the moldable plastic material and providing the base batch in an amount of 96% to 98% of the molding material; and
providing the further batch in an amount of 2% to 4% of the molding material and the ion-releasing material in an amount of approximately 10% of the further batch.

10. The method according to claim 8, which comprises forming the shopping cart with hydrophobic surfaces or with superhydrophobic surfaces.
